(19) United States
(12) Patent Application Publication
(10) Pub. No.: US 2024/0051820 A1
(43) Pub. Date: Feb. 15, 2024

(54) FUEL PRECURSOR

(71) Applicant: ROLLS-ROYCE plc, London (GB)

(72) Inventor: Sarah L. WILD, Derby (GB)

(73) Assignee: ROLLS-ROYCE plc, London (GB)

(21) Appl. No.: 18/358,249

(22) Filed: Jul. 25, 2023

(30) Foreign Application Priority Data
Aug. 11, 2022 (GB) 2211758.4

(51) Int. Cl. C01B 3/08

(52) U.S. Cl. CPC C01B 3/08; C01B 2203/0272

(57) ABSTRACT

A fuel precursor is provided for producing hydrogen fuel by reacting aluminium and water. The fuel precursor has aluminium particles suspended in a hydrophobic liquid such that when the fuel precursor is introduced to water, the suspended aluminium particles migrate to the water and react therewith to produce hydrogen. The suspended aluminium particles are non-spherical, angular particles. The surfaces of the suspended aluminium particles have substantially no oxide layer thereon

### CROSS-REFERENCE TO RELATED APPLICATIONS

This specification is based upon and claims the benefit of priority from United Kingdom patent application number GB 2211758.4 filed on Aug. 11, 2022, the entire contents of which is incorporated herein by reference.

### BACKGROUND

### Technical Field

The present disclosure relates to a fuel precursor for producing hydrogen fuel by reacting aluminium and water.

### Description of the Related Art

Due to increased energy demand and concerns around climate change and air pollution, hydrogen fuel cell technology is an increasingly popular method for electricity generation. The energy density of hydrogen is around 200 times greater than that of a lithium ion battery. However, hydrogen storage for portable devices is an ongoing challenge as compressed gas cylinders are large.

Aluminium can react with water to generate hydrogen in situ, for example according to the following reaction:

2Al+6H₂O→3H₂+2Al(OH)₃

The hydrogen can then in turn be used to power a fuel cell to generate electricity. Power modules using such technology could be used to power vehicles on land, in the air, and in marine environments.

However, a naturally occurring oxide layer on the surface of aluminium typically prevents aluminium from reacting with water.

Work has been done to find methods for bypassing the oxide layer and allowing the aluminium to react. See for example in J. Petrovic and G. Thomas, Reaction of Aluminum with Water to Produce Hydrogen: A Study of Issues Related to the Use of Aluminum for On-Board Vehicular Hydrogen Storage. US Department of Energy, Version 2, 2010:
https://www1.eere.energy.gov/hydrogenandfuelcells/pdfs/aluminium_water_hydrogen.pdf

One approach, discussed for example in J T. Slocum, T. W. Eagar, R. Taylor and D. P. Hart, Activation of bulk aluminum and its application in a hydrogen generator, Applied Energy, Volume 279, 1 Dec. 2020, is to “activate” aluminium BB (ball bearing) pellets by using a gallium-indium eutectic melt to break down the grain boundary structure and to make the internal aluminium accessible to react with water. However, the gallium-indium eutectic is expensive. Moreover, handling solid aluminium pellets presents challenges when designing a loading mechanism for the activated pellets. In particular, the activated balls are brittle, and so are liable to fracture. In addition, spherical balls have a packing density of approximately 64%, making relatively inefficient use of space.

The present disclosure has been devised in light of the above considerations.

### SUMMARY

In a first aspect, the present disclosure provides a fuel precursor for producing hydrogen fuel by reacting aluminium and water, the fuel precursor having aluminium particles suspended in a hydrophobic liquid such that when the fuel precursor is introduced to water, the suspended aluminium particles migrate to the water and react therewith to produce hydrogen, wherein:
the suspended aluminium particles are non-spherical, angular particles; and
   the surfaces of the suspended aluminium particles have substantially no oxide layer thereon.

Advantageously, the suspended aluminium particles, being substantially without an oxide layer, can react with water to produce hydrogen without recourse to activation, for example by a gallium-indium eutectic melt. Moreover, being non-spherical and angular particles, higher aluminium loadings in the fuel precursor can be achieved than with spherical pellets.

The aluminium can be pure aluminium, or an aluminium alloy which is suitably reactive with water.

Conveniently, the suspended aluminium particles may be produced by wet-ball milling aluminium feedstock particles. For example, the wet-ball milling may be performed under an inert atmosphere that substantially prevents an oxide layer forming on the fresh aluminium surfaces produced by the wet-ball milling. The inert atmosphere may be an argon or nitrogen atmosphere, or a mixed argon/nitrogen atmosphere. Conveniently, the liquid wet-ball milling may be performed using a solvent which is the hydrophobic liquid of the liquid fuel-precursor. In this way, after wet-ball milling, a desired loading of particles in the fuel precursor can be achieved simply by adding more hydrophobic liquid or removing solvent.

Preferably the suspended aluminium particles are nanoparticles, i.e. substantially all of the suspended particles may have a diameter of 100 nm or less. This increases the surface to volume ratio of the particles, and thus increases the amount of hydrogen that can be formed from a given particle before the surface of the particles is passivated.

The suspended aluminium particles may have a volume loading relative to the total volume of aluminium particles and hydrophobic liquid of at least 35%. Preferably the volume loading is at least 65%, and more preferably at least 70% or 75%, to provide a higher packing density than uniformly-sized spherical particles. Nonetheless, lower volume loadings, e.g. in the range 35% to 65%, may also provide a fuel precursor with a useful energy density in terms of amount of hydrogen producible therefrom, while giving the fuel precursor better handling characteristics than higher loadings. The volume loading in the hydrophobic liquid may be at most 85% or 80% to ensure that the fuel precursor can flow as a liquid. At higher loadings than this, the particles may effectively cease to be suspended in the liquid, the fuel precursor solidifying into a wet granular agglomerate.

The hydrophobic liquid may have a boiling point of at least 60° C. In this way, it can be readily volatilised by the exothermic reaction of aluminium with water, and removed from the reaction zone along with the produced hydrogen, thereby preventing its build up in the reaction zone.

The hydrophobic liquid may have a boiling point of at most 100° C. In this way, it can be readily condensed out of and separated from the produced hydrogen.

The hydrophobic liquid may be mineral oil, ethylene glycol, hexane or ethyl acetate.

In a second aspect, the present disclosure provides a method of producing the fuel precursor of the first aspect, the method including:
providing a mixture of aluminium feedstock particles in a solvent which is a hydrophobic liquid; and
wet ball milling the mixture under an inert atmosphere to produce the fuel precursor in which non-spherical, angular aluminium particles are suspended in the hydrophobic liquid, the suspended aluminium particles having substantially no oxide layer thereon.

The method of the second aspect may further include:
adding or removing hydrophobic liquid to adjust the loading of the suspended aluminium particles in the hydrophobic liquid.
   In a third aspect, the present disclosure provides a method of producing hydrogen fuel including:
providing the fuel precursor of the first aspect; and
introducing the fuel precursor to water, such that the aluminium particles migrate to the water and react therewith to produce hydrogen.

In the method of the third aspect, the hydrophobic liquid may be volatilised when the fuel precursor is introduced to water, and the method may further include:
removing a mixture of the produced hydrogen and the volatilised hydrophobic liquid; and
condensing the hydrophobic liquid to remove it from the mixture.

The invention includes the combination of the aspects and preferred features described except where such a combination is clearly impermissible or expressly avoided.

### DESCRIPTION OF THE DRAWINGS

Embodiments illustrating the principles of the invention will now be discussed with reference to the accompanying figures in which:

FIG. 1 shows a process flow chart for producing the liquid fuel precursor and using hydrogen fuel produced from the precursor in a fuel cell.

### DETAILED DESCRIPTION

Aspects and embodiments of the present invention will now be discussed with reference to the accompanying figures. Further aspects and embodiments will be apparent to those skilled in the art. All documents mentioned in this text are incorporated herein by reference.

A fuel precursor for producing hydrogen fuel by reacting aluminium and water is provided. The fuel precursor has aluminium particles suspended in a hydrophobic liquid.

When the fuel precursor is introduced to water, the suspended aluminium particles migrate to the water and react therewith to produce hydrogen and heat according to the exothermic reaction:

2Al+6H₂O→3H₂+2Al(OH)₃

The hydrogen can then be used in a downstream process, such as a fuel cell for the generation electricity, which in turn can be used to power electrical devices, such as vehicle propulsion motors. Depending on the application, use can generally also be made of the heat generated by the reaction. The produced aluminium hydroxide can be collected and recycled, if desired, back into aluminium production processes.

The surfaces of the suspended aluminium particles in the fuel precursor have substantially no oxide layer thereon. Normally, in air, these surfaces would oxidise immediately to form a thin but highly tenacious aluminium oxide layer, which arrests further oxidation of the particles and prevents the underlying aluminium reacting with water. However, being entirely immersed in the hydrophobic liquid, the suspended aluminium particles have no opportunity to form oxide layers, and can be stored for lengthy periods while retaining their ability to react with water and produce hydrogen. Moreover, because the particles are suspended in the hydrophobic liquid, the fuel precursor is pumpable, which facilitates handling and storage.

The aluminium particles in the fuel precursor can be produced by wet-ball milling aluminium feedstock particles under an inert atmosphere, such as argon or nitrogen atmosphere. For example, a Retsch PM100™ planetary ball mill can provide high energy levels for the milling and has a grinding chamber which is purgeable with inert gas. The feedstock can be any suitable stock metal, recycled aluminium or swarf. The aluminium itself can be pure aluminium or an aluminium alloy.

Conveniently, the solvent used for the wet-ball milling is the same hydrophobic liquid in which the aluminium particles are suspended in the fuel precursor. After wet-ball milling, a desired loading of particles in the fuel precursor can be achieved by adding more hydrophobic liquid or removing liquid. In general, the higher the loading the higher the hydrogen-producing potential of the fuel precursor. On the other hand, above a certain loading, which is generally about 80% or 85% by volume, the aluminium particles will come into greater contact with each other, and eventually the fuel precursor ceases behaving as liquid, and becomes a wet granular agglomerate. Typically, loadings in the range 35% to 80% by volume are aimed for, with loadings of at least 65%, and preferably at least 70% or 75%, advantageously providing substantially higher loadings than those associated with randomly close packed uniform spheres.

The effect of wet-ball milling on the aluminium feedstock is to produce non-spherical, angular aluminium particles with fresh, non-oxidised surfaces that can react with water even without activation by gallium-indium eutectic. These particles can be more closely packed in the liquid than spherical particles to increase the aluminium loading of the fuel precursor. To increase the surface to volume ratio of the particles, and thus to increase the amount of hydrogen that can be formed from a given particle before the reaction with water passivates the surface of the particles, the particles are preferably nanoparticles, i.e. substantially all of the suspended particles have a diameter of 100 nm or less. With such particle sizes it is possible for most, if not all, of the aluminium of each particle to react with water, whereby reaction extents of greater than 90% are achievable. Indeed, small particle sizes allow 100% reaction extents to effectively be obtained.

The hydrophobic liquid can be selected so that it is volatilised by the exothermic reaction with water, e.g. when it is pumped into a reaction vessel containing water. The vapour thus produced can be removed from reaction zone in a gas line in a gas mixture which also contains the hydrogen from the reaction. In this way, hydrophobic liquid is prevented from building up in the reaction vessel. In addition, the gas mixture may be directed into a condenser where the hydrophobic liquid condenses out for storage or recycling. Typically, the hydrogen continues on to a fuel cell where it used to generate electricity but without entraining the hydrophobic liquid vapour which could reduce the effectiveness of the cell. Thus the hydrophobic liquid can be chosen such that it has a boiling point that allows it vaporise in the reaction zone, but also allows it to readily condense in the condenser. For example the boiling point may be at last 60° C. and/or at most 100° C. Other considerations for the hydrophobic liquid are good hydrophobicity, safe chemistry, and rheological properties that provide the fuel precursor with desirable flow characteristics. For example, the hydrophobic liquid can be hexane or ethyl acetate. Other options for the hydrophobic liquid are mineral oil and ethylene glycol, although these have significantly higher boiling points than 100° C., and thus may require other engineering solutions for avoiding build-up of excess hydrophobic liquid in a reaction vessel and maintain a desired particle volume loading, such as a continuous cycle of fluid removal from the vessel, filtration and return.

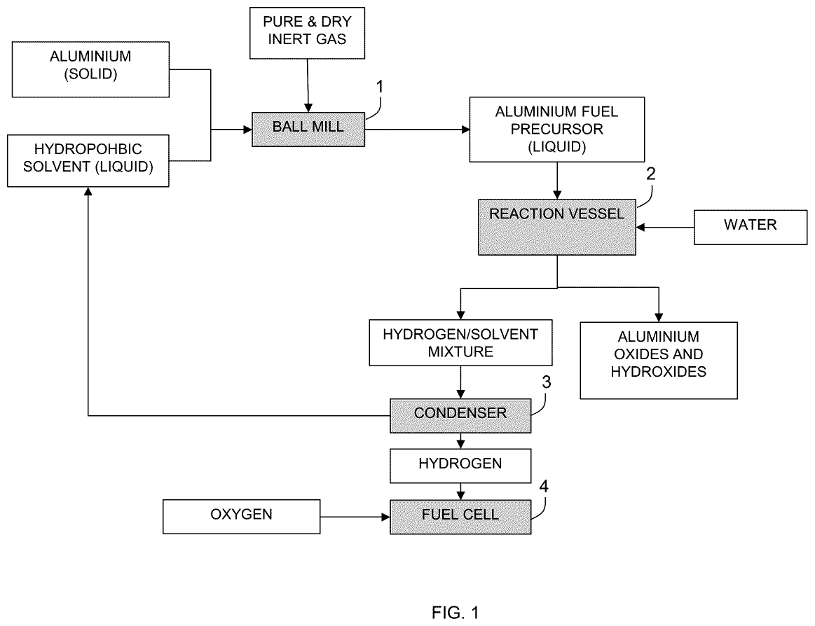

By way of example, FIG. 1 shows a process flow chart for producing the liquid fuel precursor and using hydrogen fuel produced from the precursor in a fuel cell. In a first stage of the process, the liquid fuel precursor is produced in a ball mill 1 under an inert gas from solid aluminium and a hydrophobic solvent (liquid). Next the fuel precursor is reacted with water in a reaction vessel 2. This results in a mixture of produced hydrogen and the solvent which is removed as one stream from the reaction vessel 2, and aluminium oxides and hydroxides which are removed as another stream from the vessel. The solvent is extracted from the mixture in a condenser 3 and returned to the first stage to be used in the production of more fuel precursor. The hydrogen is sent on from the condenser 3 to a fuel cell 4 where it is reacted with oxygen to generate electricity.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example+/−10%.

### REFERENCES

A number of publications are cited above in order to more fully describe and disclose the invention and the state of the art to which the invention pertains. Full citations for these references are provided below. The entirety of each of these references is incorporated herein.
J. Petrovic and G. Thomas, Reaction of Aluminum with Water to Produce Hydrogen: A Study of Issues Related to the Use of Aluminum for On-Board Vehicular Hydrogen Storage. US Department of Energy, Version 2, 2010. https://www1.eere.energy.gov/hydrogenandfuelcells/pdfs/aluminium_water_hydrogen.pdf
J T. Slocum, T. W. Eagar, R. Taylor and D. P. Hart, Activation of bulk aluminum and its application in a hydrogen generator, Applied Energy, Volume 279, 1 Dec. 2020.

1. A fuel precursor for producing hydrogen fuel by reacting aluminium and water, the fuel precursor having aluminium particles suspended in a hydrophobic liquid such that when the fuel precursor is introduced to water, the suspended aluminium particles migrate to the water and react therewith to produce hydrogen, wherein:
the suspended aluminium particles are non-spherical, angular particles; and
the surfaces of the suspended aluminium particles have substantially no oxide layer thereon.

2. The fuel precursor according to claim 1, wherein the suspended aluminium particles are produced by wet-ball milling aluminium feedstock particles.

3. The fuel precursor according to claim 2, wherein the wet-ball milling is performed under an inert atmosphere that substantially prevents an oxide layer forming on the fresh aluminium surfaces produced by the wet-ball milling.

4. The fuel precursor according to claim 2, wherein the liquid wet-ball milling is performed using a solvent which is the hydrophobic liquid of the liquid fuel-precursor.

5. The fuel precursor according to claim 1, wherein the suspended aluminium particles are nanoparticles.

6. The fuel precursor according to claim 1, wherein the suspended aluminium particles have a volume loading relative to the total volume of aluminium particles and hydrophobic liquid of at least 65%.

7. The fuel precursor according to claim 1, wherein the hydrophobic liquid has a boiling point of at least 60° C.

8. The fuel precursor according to claim 1, wherein the hydrophobic liquid has a boiling point of at most 100° C.

9. The fuel precursor according to claim 1, wherein the hydrophobic liquid is mineral oil, ethylene glycol, hexane or ethyl acetate.

10. A method of producing the fuel precursor of claim 1, the method including:
providing a mixture of aluminium feedstock particles in a solvent which is a hydrophobic liquid; and
wet ball milling the mixture under an inert atmosphere to produce the fuel precursor in which non-spherical, angular aluminium particles are suspended in the hydrophobic liquid, the suspended aluminium particles having substantially no oxide layer thereon.

11. The method of claim 10, further including:
adding or removing hydrophobic liquid to adjust the loading of the suspended aluminium particles in the hydrophobic liquid.

12. The method of claim 10, wherein the hydrophobic liquid is volatilised when the fuel precursor is introduced to water, and the method further includes:
removing a mixture of the produced hydrogen and the volatilised hydrophobic liquid; and
condensing the hydrophobic liquid to remove it from the mixture.

13. A method of producing hydrogen fuel, the method including:
providing the fuel precursor of claim 1; and
introducing the fuel precursor to water, such that the aluminium particles migrate to the water and react therewith to produce hydrogen.
